(19) United States
(12) Patent Application Publication
(10) Pub. No.: US 2018/0310380 A1
(43) Pub. Date: Oct. 25, 2018

(54) LIGHTING EFFECTS

(71) Applicant: PHILIPS LIGHTING HOLDING B.V., EINDHOVEN (NL)

(72) Inventor: Dzmitry Viktorovich ALIAKSEYEU, EINDHOVEN (NL)

(21) Appl. No.: 15/769,290

(22) PCT Filed: Oct. 21, 2016
(86) PCT No.: PCT/EP2016/075410

§ 371 Date: Apr. 18, 2018

(30) Foreign Application Priority Data
Oct. 26, 2015 (EP) 15191433.0

(51) Int. Cl. H05B 33/08; F21V 14/06; F21S 2/00; H05B 37/02; H02J 7/02; F21S 9/02

(52) U.S. Cl. CPC H05B 33/0863; F21V 14/06; F21S 9/02; H05B 37/0272; H02J 7/025; F21S 2/005

(57) ABSTRACT

A system comprising: apparatus (100) comprising a formation of transducers (102), each arranged to convey pressure through a fluid above the apparatus, wherein the fluid is a gas; one or more lighting objects (108a, 108b); and a controller (416,418) configured to control the transducers in order to spatially direct a combined effect of the pressure from the transducers, and thereby levitate the one or more lighting objects (108a, 108b) in the fluid above the apparatus.

### TECHNICAL FIELD

The present disclosure seeks to find new ways to provide lighting effects through a system comprising one or more light sources such as LED-based light sources.

### BACKGROUND

LED based lighting is versatile in creating static and dynamic light effects. For instance, LED based light sources can be used to illuminate rooms or other environments, or to make people feel better, or can be used as actuators for signaling events, or to transmit data. Furthermore, the compact form of LEDs means they can be packaged into new form factors and used in areas that were previously unsuitable for lighting such as in the floor or embedded into a building's architecture.

While LED lighting has allowed light designers to create new forms of luminaires, so far such designs have nonetheless been limited to designing the shape of the luminaires, their location, dimming levels, colors, and dynamic effects.

### SUMMARY

It would be desirable to seek out new technologies for creating lighting effects. According to the present disclosure, the versatility of LED lighting is combined with versatility of pressure-based levitations technologies such as ultrasound-based levitation, which uses an array of ultrasonic transducers to float a lightweight object or even to simultaneously float a plurality of such lightweight objects.

One of the advantages of LED based lighting is that the light source can be made very small and light weight. It is recognized herein that this makes LED light sources suitable for combination with new technologies like ultrasound based levitation, thereby opening up new ways of creating lighting effects, such as to provide a dynamic multi-node luminaire.

Also other types of lightweight light sources may be used, e.g. chemoluminescent or bioluminescent light sources.

According to one aspect disclosed herein, there is provided a system comprising: apparatus comprising a formation of transducers, each arranged to convey pressure through a fluid, wherein the fluid is a gas (e.g. air), above the apparatus; one or more lighting objects; and a controller configured to control the transducers in order to spatially direct a combined effect of the pressure from the transducers, and thereby levitate the one or more lighting objects in the fluid above the apparatus.

In embodiments, said transducers are ultrasound transducers, each arranged to emit an ultrasonic wave with a respective phase; and the controller is configured to perform said control by controlling the respective phases of the ultrasonic waves, relative to one another, in order to levitate the one or more lighting objects above the apparatus using the ultrasonic waves.

In embodiments, each of one or more of the lighting objects may comprise a levitatable light source which emits light.

In embodiments, the system may further comprise one or more charging coils, arranged such that each of the one or more levitatable light sources will settle into a charging field of one of the charging coils when the pressure from the transducers is turned off, in order to recharge the levitatable light sources.

In embodiments, one or more of the lighting objects may not themselves comprise light sources but rather may be passive optical elements which scatter light, and the system may comprise one or more separately-located light sources arranged to emit the light toward the passive optical elements for scattering.

In embodiments, said separately-located light sources may be embedded amongst the formation of transducers in the apparatus.

In embodiments, the light sources may be LED-based light sources each comprising one or more LEDs configured to emit said light.

In embodiments, said one or more lighting objects may be a plurality of lighting objects.

In embodiments, said one or more charging coils may be a plurality of charging coils, arranged such that each of the lighting objects will settle into the charging field of a different respective one of the charging coils when the pressure from the transducers is turned off.

In embodiments, the formation of the transducers may be a regular array.

In embodiments, the light sources may be embedded in a regular pattern amongst the array of transducers.

In further embodiments, the system may further comprise one or more sensors (e.g. a camera) arranged to provide feedback on a position of each of the one or more lighting objects while levitated by the transducers, and the controller may be configured to adjust the relative phases based on said feedback to maintain a desired position of the one or more sensors (despite external perturbations to the positions such as an air draft or interference by a user).

According to another aspect disclosed herein, there is provided a method of using an apparatus comprising a formation of transducers, each arranged to convey pressure through a fluid above the apparatus, wherein the fluid is a gas; the method comprising: controlling the transducers in order to spatially direct a combined of the pressure from the transducers, and thereby levitate one or more lighting objects in the fluid above the apparatus.

According to another aspect disclosed herein, there is provided a computer program product for operating an apparatus comprising a formation of transducers, each arranged to convey pressure through a fluid above the apparatus, wherein the fluid is a gas; the computer program product comprising code embodied on a computer-readable storage medium and configured so as when run on one or more processors to: control the transducers in order to spatially direct a combined effect of the pressure from the transducers, and thereby levitate one or more lighting objects in the fluid above the apparatus.

In embodiments, the method may comprise and/or the computer-program product may be configured to perform further operations in accordance with any of the system features disclosed herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic diagram of an ultrasound based levitation system,

FIG. 2 is a schematic illustration of a system of embedded light sources and floating optical elements,

FIG. 3 is a schematic illustration of a system of floating light sources and embedded charging coils,

FIG. 4 is a schematic block diagram of a system of embedded light sources and floating optical elements, and

FIG. 5 is a schematic block diagram of a system of floating light sources.

### DETAILED DESCRIPTION OF EMBODIMENTS

The following describes a method for creating a new type of dynamic multimode luminaire. The main elements are combination of ultrasound-based levitation technology (that can float multiple light weight objects) and light weight LED modules or optical elements. Such a combination can be achieved in two ways: (i) by embedding a matrix of collimated light sources into a surface of the ultrasonic transducers, and using optical elements that can be floated above the surface to scatter the light; or (ii) by floating led modules each with embedded LED light source and a small battery. Different dynamic effects can then be created by dynamically repositioning the optical elements above the surface of the transducer apparatus and/or by turning the optical elements (ultrasound-based levitation technology allows floated objects to be dynamically positioned and rotated). for avoidance of doubt, note that the term “float” as used herein does not refer to buoyancy, but rather to suspension by emission of pressure through a fluid from suitable transducers (also referred to herein as “levitation”).

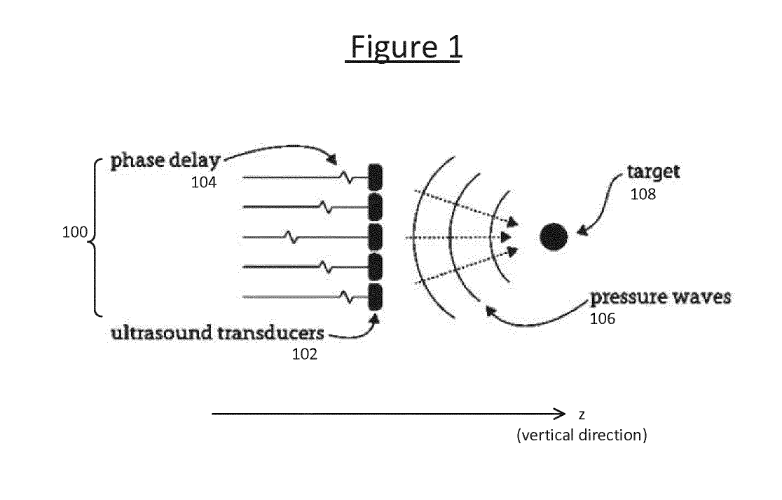

FIG. 1 illustrates the principle of ultrasound-based levitation, which uses an ultrasound apparatus 100 to float an object 108 in a fluid above the apparatus (the fluid typically being a gas such as air). Note that the vertical direction z is shown from left to right in FIG. 1. The ultrasound apparatus 100 comprises an array of ultrasound transducers 102, each arranged to emit a respective ultrasound wave into the air above the apparatus 100, each with a respective phase 104. By using a suitable software or hardware controller to control the phases 104 (and in embodiments amplitudes) of the ultrasonic waves emitted by the different transducers in the array, it is possible to levitate the object 108 (or more than one such object) in the air above the apparatus 100. This principle in itself is known, and may be referred herein to as ultrasound-based levitation. For reference, see for example:

[1] “Ultra-Tangibles: Creating Movable Tangible Objects on Interactive Tablets”, Mark T Marshall et al, Proceedings of the 2012 ACM annual conference on Human Factors in computing Systems, ACM 10.1145/2207676.2208370;

[2] “UltraHaptics: Multi-Point Mid-Air Haptic Feedback for Touch Surfaces”, Tom Carter et al, 2013 ACM 978-1-4503-2268;

[3] “Noncontact Tactile Display Using Airborne Ultrasound”, Takayuki Hoshi, Nagoya Institute of Technology, ASSN-L 1883-2490/21/1529, 2014 ITE & SID.

Typically the array of transducers 102 is a regular array (equidistant spacing between the transducers 102, with the spacing between a given transducer 102 and each of its neighbors being part of a repeating pattern of such spacings from one neighbor to the next). The array is also in embodiments a 2D array in the horizontal plane. However in general any formation of transducers 102 may be used as long as the relative spacings are known when configuring the controller. Further, while preferably the array employs a large number of transducers 102 to achieve the levitation (e.g. ten or more, or even a hundred or more), in general there is no strict prescribed number and in principle as few as three or four transducers 102 may be used.

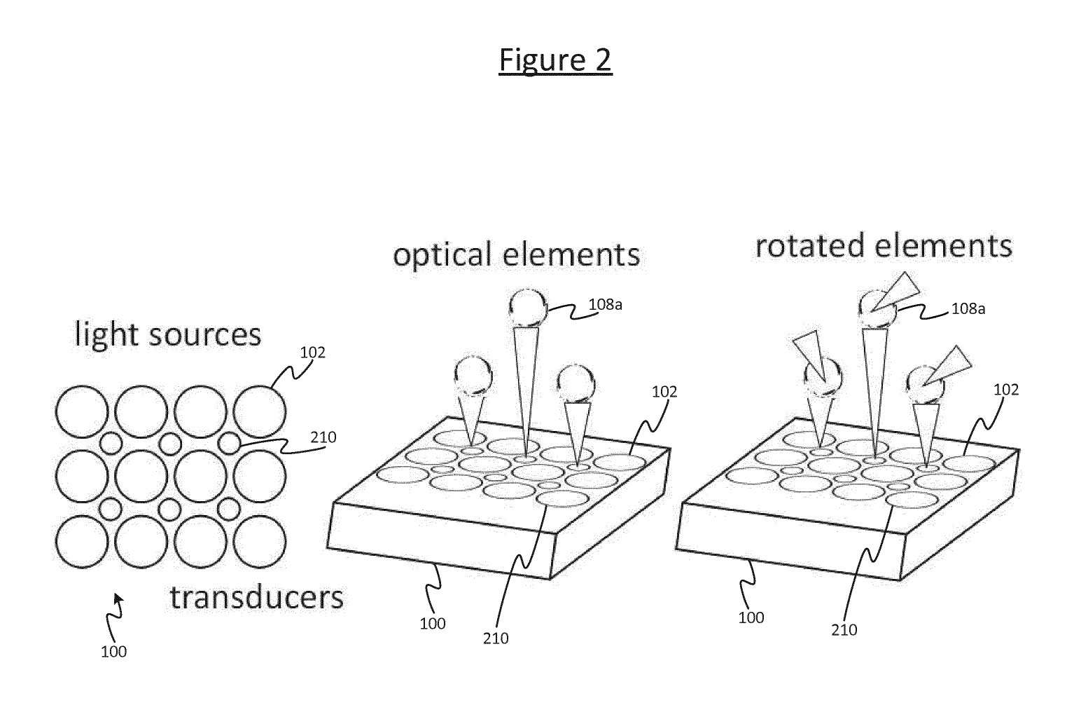

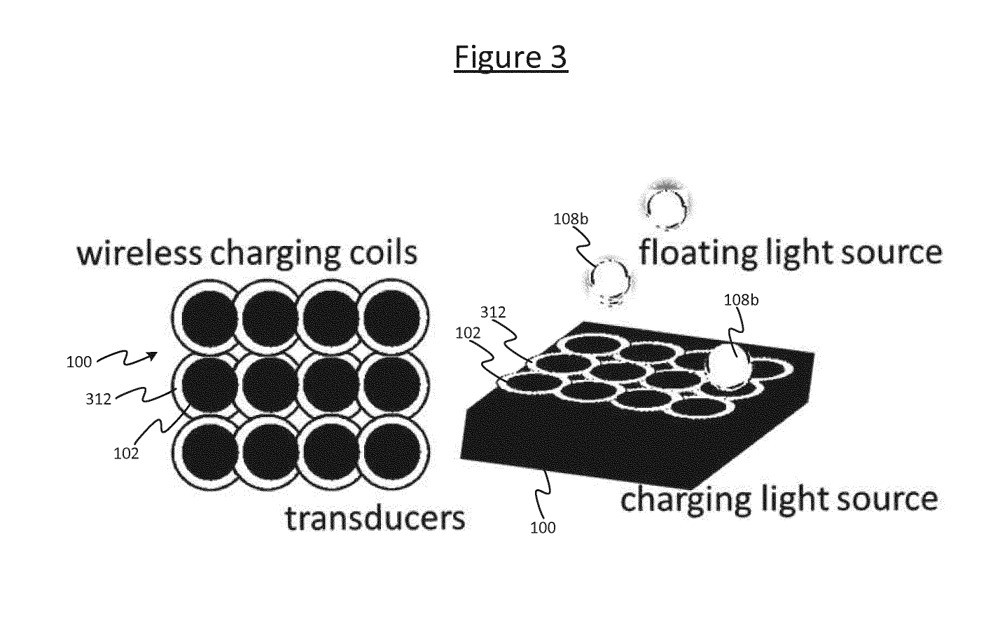

As illustrated in FIGS. 2 and 3, an array of ultrasound transducers 102 such as described in relation to FIG. 1 can be used to suspend one or more lighting objects 108a, 108b in the air above the ultrasound apparatus 100 (with no other means of support).

FIG. 2 shows an example of a system in which the lighting objects are passive optical elements 108a for scattering light, illuminated by light sources 210 located elsewhere but directed towards the optical elements 108a. Particularly, in the embodiment of FIG. 2, a matrix of collimated light sources 210 is embedded into an upper surface of the ultrasound apparatus 100 along with the ultrasonic transducers 102, the light sources 210 being interspersed between the transducers 102 in a regular pattern and directed vertically upwards, embedded in the same upper surface of the apparatus 100 as the transducers 102. In embodiments the light sources 210 are LED-based light sources, each comprising one or more LEDs. By floating the optical elements 108a above the surface, the light sources 210 and optical elements 108a are together arranged to scatter the light and thereby create a novel form of lighting effect. Preferably, this arrangement is used to create a dynamic light effect.

The embedded light sources 210 can have different capabilities e.g. colored light, white light etc. Similarly the optical elements 108a can have different light scattering capabilities that could allow a large variety of achievable light effects. Note also that instead of the multiple light sources 210, one multi directional light source embedded in the center of the surface with the transducers 102 can alternatively be used. In this case however the diversity of achievable light dynamics might be limited.

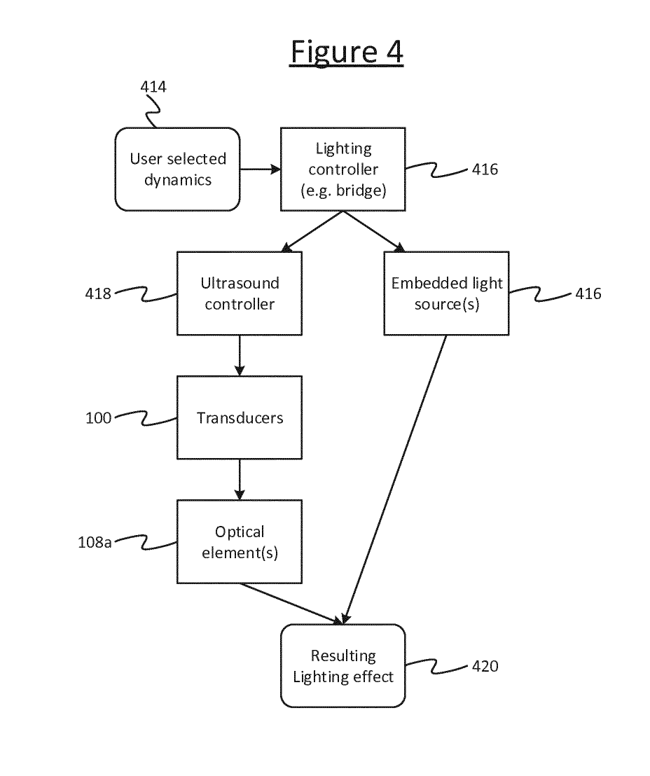

FIG. 4 gives a block diagram further illustrating the system of FIG. 2. The system comprises an ultrasound controller 418 that is connected to control the transducers 102, and a lighting controller 416 connected to the ultrasound controller 418. The lighting controller 416 is also connected to the light sources 210. Each of the connections between the ultrasound controller 418 and transducers 102, between the lighting controller 416 and ultrasound transducer 418, and between the lighting controller 416 and light sources 210, may be implemented by any suitable wired or wireless means (and each of these connections need not be by the same means). For example, in embodiments, the ultrasound controller 418 is integrated in the ultrasound apparatus, while the lighting controller 416 may be implemented in a lighting control bridge such as the Philips hue bridge which provides an interface between the lighting and a user terminal such as smartphone, tablet or laptop (not shown). E.g. the bridge comprising the lighting controller 416 connects to each of the ultrasound controller 418 and light sources 210 via a first wireless access technology such as ZigBee, and connects to the user terminal via a second, different wireless access technology such as Wi-Fi.

The lighting controller 416 is configured to receive a user input 414. E.g. in the case where the lighting controller is implemented on a user terminal, it may receive the user input 414 from a lighting control application running on the user terminal. The user input 414 specifies a lighting effect to be rendered by the system, preferably a dynamic lighting effect. The lighting controller 416 can then request a specific lighting configuration expressed in terms of locations and movements of the optical elements, and control the embedded light sources 210 for the desired effect. That is, the lighting controller 416 switches on or off, or controls the dimming level and/or color, of the illumination emitted by each of one or more the light sources 210; and simultaneously (via the ultrasound controller 418) controls the relative phases (and in embodiments amplitudes) of the ultrasound waves emitted by the ultrasound transducers 102 in order to levitate one or more of the optical elements 108a based on ultrahaptic techniques to a position at which they are illuminated by the illumination from the controlled light sources 210.

Furthermore, ultrasound-based levitation technology allows to dynamically move floated objects, either by rotating them or moving them laterally (horizontally and/or vertically, i.e. translational motion). Based on this ability, preferably, different dynamic effects are also created (based on the user input 414) by dynamically repositioning the optical elements 108a laterally in the space above the array of transducers 102, and/or by turning the optical elements 108a. Thus dynamic lighting effects 420 can be created.

FIG. 3 shows an example of an alternative version of the system in which the lighting objects are themselves active light sources 108b, each taking the form of an LED module with one or more embedded LEDs and a small battery arranged to power the respective LED(s). Similarly to the optical elements 108a, multiple such LED modules 108b can be floated at the same time, and dynamic lighting can be achieved by changing the height and/or horizontal position of the modules 108b, and/or by rotating them. The floating LED modules 108b can have different capabilities e.g. colored light, white light etc.

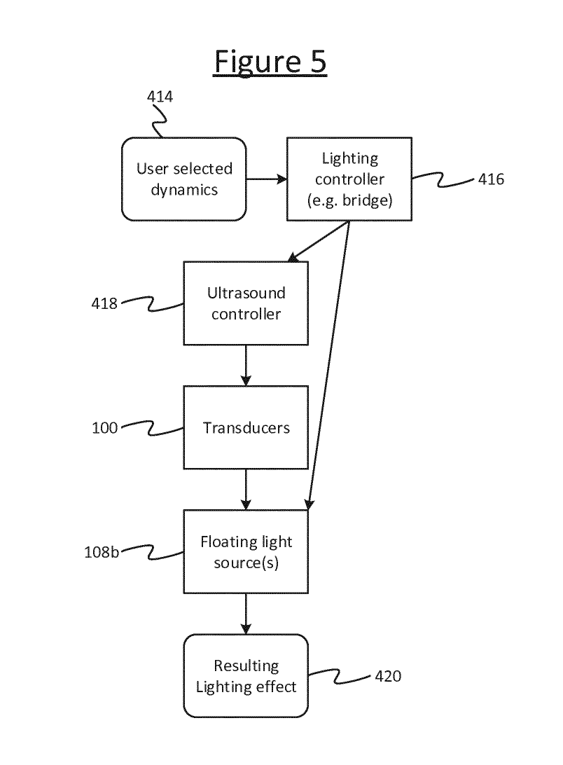

FIG. 5 gives a block diagram further illustrating the system of FIG. 3. The setup is similar to that of FIG. 4, except that the lighting controller 416 is configured to control the floating light sources 108b instead of the embedded light sources 210. That is, the lighting controller 416 is configured turn on or off, and/or control the dimming level and/or color, of one or more of the floating light sources 108b, and thereby create a static or dynamic lighting effect based on the user input 414 (with the levitation being performed in a similar manner as discussed in relation to FIG. 4). This control may be performed via any suitable wireless connection such as a ZigBee connection (e.g. again with the lighting controller 416 being implemented on a lighting control bridge configured to receive the user input 414 from a user terminal via another type of wireless connection such as Wi-Fi). In further embodiments, the upper surface of the apparatus 100 (in which the ultrasonic transducers 102 are incorporated) can be equipped with a matrix of wireless charging coils 312 such that when discharged the lighting modules 108b can be automatically floated back to the surface or very close to it for a recharge. That is, the controller 416 is configured to automatically control each of the light sources 108b (via the ultrasound controller 418 and transducer array) to float down into the field of a charging coil 312 to recharge the battery powering the respective light source 108b. This may be based on status reports which the controller 416 receives from the floating light sources 108b via its wireless connection, the status reports comprising the respective battery level of each respective light source 108b. I.e. a floating LED module 108b can report to the lighting system the battery level, and depending on the level the lighting controller 414 might request a transducers control system to float the said light module on to the surface for a recharge. Alternatively the lighting controller 416 may just control the light sources 108b to move to the charging position when the lighting system is turned off by the user (e.g. via the application on the user terminal).

In the embodiment shown in FIG. 3, there is one charging coil 312 per floatable light source 108b, such that all of the light sources 108b can be charged simultaneously. E.g. one respective coil 312 may be located beneath the position of each of the floating light sources 108b (or beneath a respective default or nominal position of each if dynamically positionable). Alternatively, not all surface but only part of the surface can be embedded with one or more charging coils 312 since it will be possible for the lighting controller 416 to float the light source modules 108b to the position required for charging.

In further embodiments, the system may also use a combination of passive optical elements 108a and active light sources 108b as the floating lighting objects. In another extension to the disclosed system, the apparatus 100 with the transducers 102 can itself also be a light source to, for example, provide a downlight in case of the hanging luminaire.

In yet another extension, instead of or in addition to enabling the user to specify a lighting effect 414 and have the lighting controller 416 automatically control the light sources 210,108b and the positions and/or directions of the floating lighting objects, the lighting controller 416 may alternatively or additionally be configured to allow the user to explicitly reposition the optical elements 108a or floating light modules 108b. E.g. the lighting controller 416 may accept a input from a lighting control application running on the user terminal (e.g. smartphone or tablet) specifying a position and/or angle selected by the user through the application for each of one or more of the lighting objects 108a, 108b.

In yet another extension, the current location of the floating lighting objects 108a, 108b can be either tracked by an external camera or a camera embedded in the upper surface of the haptic apparatus 100 (the same surfaces as the transducers 102). A camera is not required and in embodiments the controller 418 may control the location of the lighting objects 108a, 108b “blindly” based on analytical understanding of the effect of the ultrasound waves and their phase differences alone. Nonetheless, if a camera is added (not shown) then in embodiments this can be used to provide a feedback loop to the ultrasound controller 418 to report the exact position of floating objects 108a, 108b and then ultrasound controller 418 if needed can adjust the phases (and/or in embodiments amplitudes) of the waves emitted from the transducers 102 in order to adjust the positions of the objects 108a, 108b. For example consider a situation when one of the elements has been displaced because of the air draft, or has been touched by the user—without the camera the system, the ultrasound controller 418 will not be aware of this and won't be able to correct it; but with a camera (or other such sensory feedback system) it can do it. Moreover with a camera the user can manually “design” the luminaire by physically reposting these elements. In this case the camera would detect the location and use the ultrasonic transducers 102 to maintain it.

The techniques disclosed herein can be used in a variety of applications, such as a high-end home luminaire, an iconic luminaire for a hotel lobby, etc. Highly dynamic luminaires can also be used for a psychological therapy e.g. “snoezelen” light sources.

It will be appreciated that the above embodiments have been described by way of example only.

For instance, the scope of the present disclosure is not just limited to LED based light sources, e.g. could be chemoluminescent or bioluminescent light source. Also where light source is embedded in array and lighting elements are passive optical elements arranged to scatter light from the embedded light sources, then the light sources could take other forms such as traditional filament bulbs.

Further, the fluid in which the lighting objects 108a, 108b are levitated, and in which the ultrasound waves propagate in order to do so, need not necessarily be air in general this could be any fluid through which ultrasonic acoustic pressure waves can propagate, e.g. another gas.

Furthermore, the technology used to levitate the lighting object(s) 108a, 108b in the air (or other fluid) is not necessarily limited to ultrasound. Alternatively, it is instead possible to use an array of air jets (or just created in some other fluid). In this case the lighting object(s) 108a, 108b may be levitated by controlling the relative strengths and/or directions of the jets. Nonetheless, ultrasound based levitation gives a greater degree of control and so may be preferred for most embodiments.

Each of the lighting controller 416 and ultrasound controller 418 may be implemented in software stored on memory (comprising one or more memory devices) and arranged to run on a processing apparatus (comprising one or more processing units). Alternatively one or both of these controllers 416, 418 may be each be implemented in dedicated hardware circuitry, or configurable or reconfigurable hardware circuitry such as a PGA or FPGA, or any combination of hardware and software. Further, the lighting controller 416 may be implemented in a same unit as the ultrasound controller 418, or in a different unit. For example as mentioned, the lighting controller 416 may be implemented in a lighting control bridge arranged to interface with a user terminal (not shown) to receive the user input 414 via a first wireless access technology such as Wi-Fi, while the ultrasound controller 418 may be embedded in the ultrahaptic apparatus 100 itself and arranged to interface with the lighting controller 416 on the bridge via a second wireless access technology such as ZigBee. As an alternative example, both the lighting controller 416 and ultrasound controller 418 may be implemented together in an application running on a user terminal such as a smartphone, tablet or laptop and arranged to control the light sources 210, 108b and ultrasound transducers 102 directly via a wireless access technology such as Wi-Fi or ZigBee without the need for a bridge. As another alternative example, both the lighting controller 416 and ultrasound controller 418 may be implemented together into the ultrasound transducers 102, integrated into a standalone unit along with the transducers 102. In this case the unit may be provided with any suitable remote or embedded user interface to receive the user input 414, e.g. embedded buttons or an embedded touchscreen, or a dedicated remote control device. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system comprising:
apparatus comprising a formation of transducers, each arranged to convey pressure through a fluid, wherein the fluid is a gas, above the apparatus;
one or more lighting objects; and
a controller configured to control the transducers in order to spatially direct a combined effect of the pressure from the transducers, thereby levitating the one or more lighting objects in the fluid above the apparatus.

2. The system of claim 1, wherein:
said transducers are ultrasound transducers, each arranged to emit an ultrasonic wave with a respective phase; and
the controller is configured to perform said control by controlling the respective phases of the ultrasonic waves, relative to one another, in order to levitate the one or more lighting objects above the apparatus using the ultrasonic waves.

3. The system of claim 1, wherein said fluid is air.

4. The system of claim 1, wherein each of one or more of the lighting objects comprises a levitatable light source which emits light.

5. The system of claim 4, further comprising one or more charging coils, arranged such that each of the one or more levitatable light sources settles into a charging field of one of the charging coils when the pressure from the transducers is turned off, in order to recharge the levitatable light sources.

6. The system of claim 1, wherein one or more of the lighting objects are passive optical elements which scatter light, and wherein the system comprises one or more separately-located light sources arranged to emit the light toward the passive optical elements for scattering.

7. The system of claim 6, wherein said separately-located light sources are embedded amongst the formation of transducers in the apparatus.

8. The system of claim 4, wherein the light sources are LED-based light sources each comprising one or more LEDs configured to emit said light.

9. The system of claim 1, wherein said one or more lighting objects comprise a plurality of lighting objects.

10. The system of claim 5, wherein said one or more charging coils include a plurality of charging coils, arranged such that each of the lighting objects settles into the charging field of a different respective one of the charging coils when the pressure from the transducers is turned off.

11. The system of claim 1, wherein the formation of the transducers is a regular array.

12. The system of claim 11, wherein the light sources are embedded in a regular pattern amongst the array of transducers.

13. The system of claim 2, wherein the controller is further configured to use the control of the relative phases of the ultrasonic waves in order to move the one or more lighting objects while levitated, the movement comprising one or both of:
rotation of the one or more lighting objects while levitated, and
lateral movement of the one or more lighting objects while levitated.

14. A method of using an apparatus comprising a formation of transducers, each arranged to convey pressure through a fluid above the apparatus, wherein the fluid is a gas; the method comprising:
controlling the transducers in order to spatially direct a combined of the pressure from the transducers, and thereby levitate one or more lighting objects in the fluid above the apparatus.

15. A computer program product for operating an apparatus comprising a formation of transducers, each arranged to convey pressure through a fluid above the apparatus, wherein the fluid is a gas; the computer program product comprising code embodied on a non-transitory computer-readable storage medium and configured so as when run on one or more processors to:
control the transducers in order to spatially direct a combined effect of the pressure from the transducers, thereby levitating one or more lighting objects in the fluid above the apparatus.
